(19) United States
(12) Patent Application Publication
(10) Pub. No.: US 2009/0019120 A1
(43) Pub. Date: Jan. 15, 2009

(54) METADATA-ENHANCED INSTANT-MESSAGING APPLICATIONS

(75) Inventor: Naveenkumar V. Muguda, Cary, NC (US)

Correspondence Address: IBM RALEIGH IPLAW (DG);C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 11/777,735

(22) Filed: Jul. 13, 2007

(51) Int. Cl. G06F 15/16

(52) U.S. Cl. 709/206

(57) ABSTRACT

Described herein is a metadata-enhanced instant-messaging application and device. The metadata-enhanced instant-messaging application can create and receive instant-messages that contain data and metadata. The metadata, for example, can contain a type that relates to the data. The metadata-enhanced instant-messaging application can analyze the metadata, such as by ascertaining the type contained or described within the metadata. Furthermore, the metadata-enhanced instant-messaging application can associate the data and metadata based on the information in the meta-data, such as by reading the type contained within the metadata and associating software application that can consume the data and metadata described by the type. In addition, the metadata-enhanced instant-messaging application can provide the data and metadata to the software application to consume the data and metadata.

### FIELD

Embodiments of the inventive subject matter relate generally to the field of electronic communication software and more particularly to the field of instant-messaging applications and devices.

### BACKGROUND OF THE INVENTION

Instant-messaging applications allow people to communicate non-verbally in a nearly instantaneous way. Originally, instant-messaging applications were built for friends and colleagues to chat mostly for fun and friendly communications. However, as instant-messaging use has increased in popularity, individuals in all walks of life have begun to see the appeal of non-verbal, near-instantaneous communication, especially for business related communication. Consequently, programmers have begun to accommodate to this wide-spread use of instant-messaging by building more powerful and more complex instant-messaging applications.

### SUMMARY

Described herein are embodiments of a metadata-enhanced instant-messaging application and device. In some embodiments a method can comprise analyzing metadata included in an instant-message, wherein the instant-message also contains data; associating the data and metadata with a software application that can consume the data and metadata; and providing the data and metadata to the software application to consume the data and metadata. In some embodiments the data comprises electronic information embedded in the instant-message. In some embodiments, the metadata is of a type that characterizes the data. In some embodiments, the metadata contains information selected from the group consisting of a type that characterizes the data, an attribute of the data, time and date, and higher types. In some embodiments, the method can further comprise inserting an entry into an application registry where the entry indicates the type and the software application. In some embodiments, the method can further comprise allowing a user to select from a list of available software applications to associate the data and metadata with the software application. In some embodiments, the metadata is not displayed in the instant-messaging application. In some embodiments, the instant-messaging application is configured to recognize the type and provide the data and metadata to the software application.

### BRIEF DESCRIPTION OF THE SEVERAL VIEWS OF THE DRAWINGS

The present invention is illustrated by way of example and not limitation in the Figures of the accompanying drawings in which:

FIG. 1 illustrates a metadata-enhanced instant-messaging network 100, according to some embodiments of the invention.

FIG. 2 is an illustration of an architecture 200 of a metadata-enhanced instant-messaging application device 206, according to some embodiments of the invention.

FIG. 3 is a block diagram illustrating a computer system 300, according to some embodiments of the invention.

FIG. 4 is a flow diagram of a method 400 according to some embodiments of the invention.

FIG. 5 illustrates an embodiment of method 400 in an operating environment and will be described in concert with FIG. 4, according to some embodiments of the invention.

FIG. 6 is a flow diagram of a method 600 according to some embodiments of the invention.

FIG. 7 illustrates an embodiment of method 600 in an operating environment and will be described in concert with FIG. 6, according to some embodiments of the invention.

FIG. 8 is a flow diagram of a method 800 according to some embodiments of the invention.

FIG. 9 illustrates an embodiment of method 800 in an operating environment and will be described in concert with FIG. 8, according to some embodiments of the invention.

FIG. 10 is a flow diagram of a method 1000 according to some embodiments of the invention.

FIG. 11 illustrates an embodiment of method 1100 in an operating environment and will be described in concert with FIG. 10, according to some embodiments of the invention.

### DETAILED DESCRIPTION

Metadata-enhanced instant-messaging applications are described herein. This description of the embodiments is divided into three sections. The first section describes example operating environments, while the second section operations performed in some embodiments of an operating environment. The third section provides some general comments.

### Example Operating Environments

This section describes example operating environments and provides structural aspects of some embodiments.

### Metadata-Enhanced Instant-Messaging Application Device Network

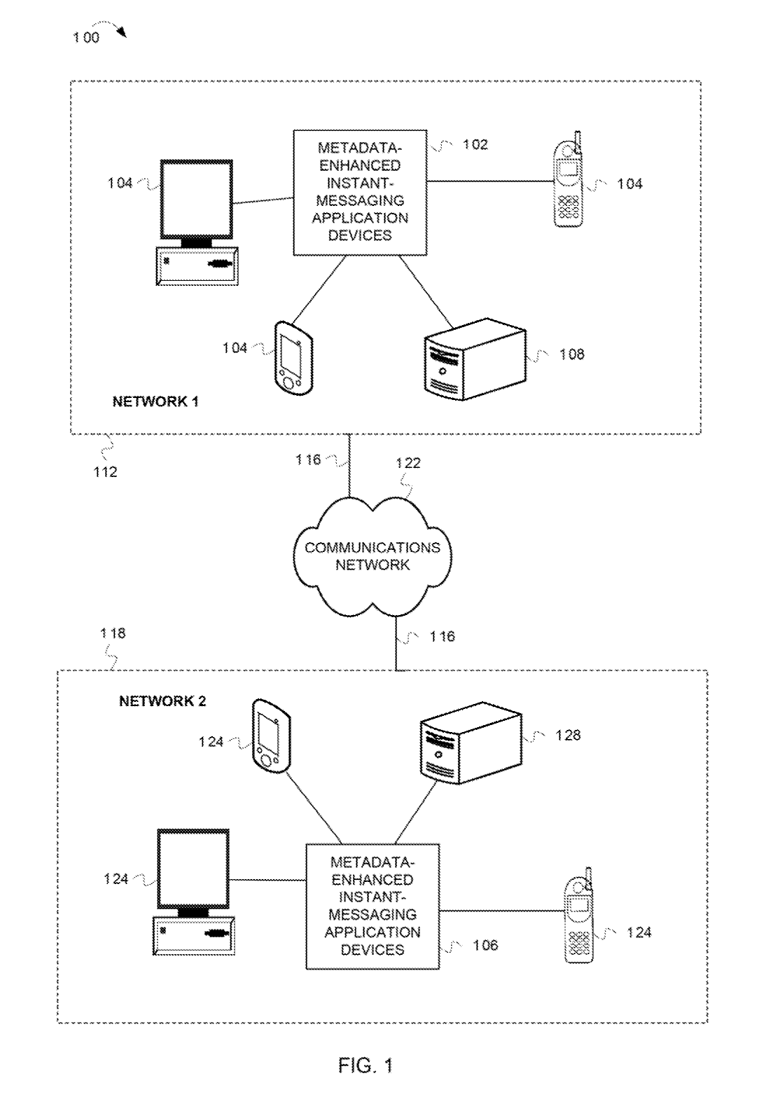

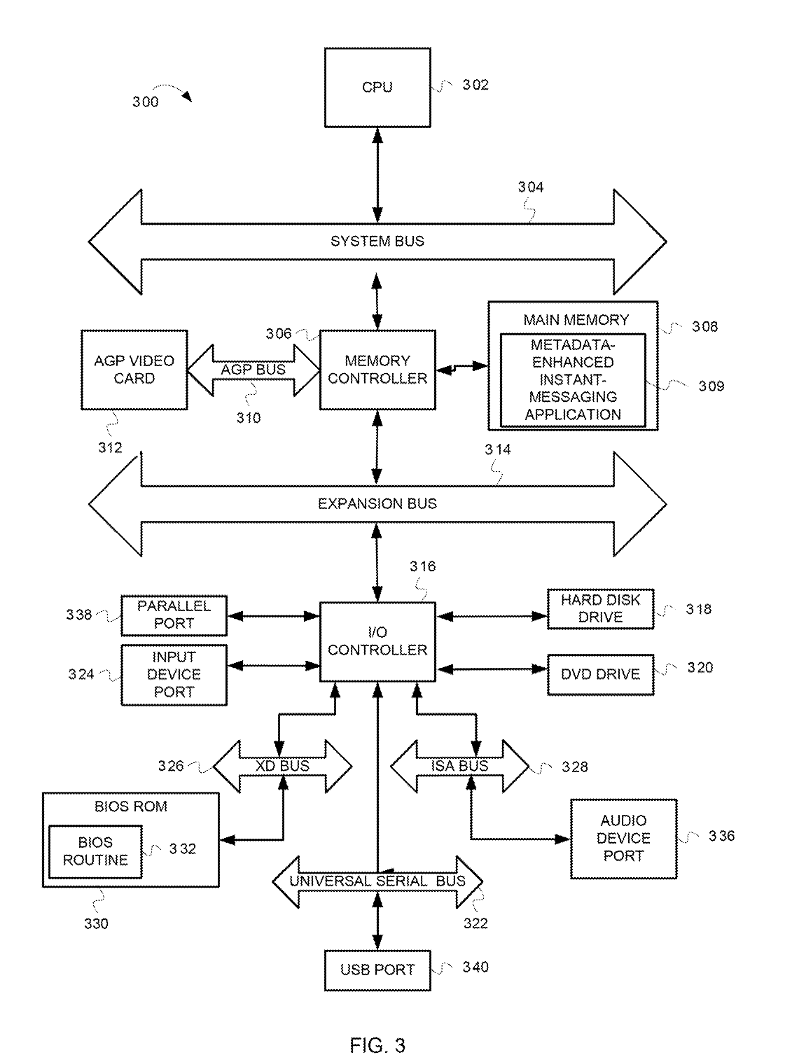

FIG. 1 illustrates a metadata-enhanced instant-messaging network 100, according to some embodiments of the invention. In FIG. 1, the metadata-enhanced instant-messaging network 100 includes a first network 112 that includes network devices 104, 108, 124, 128 that can use metadata-enhanced instant-messaging application devices 102, 106. Example network devices 104, 108, 124, 128 include personal computers, personal digital assistants, mobile telephones, mainframes, minicomputers, laptops, servers, or the like. In FIG. 1, network devices 104, 124 can be client devices that can work in conjunction with servers 108, 128. Any one of these devices can be embodied as the computer system described in FIG. 3. A communications network 122 connects a second network 118 to the first network 112, via communication lines 116. The second local network 118 also includes devices 124 and a server 128 that can use metadata-enhanced instant-messaging applications.

The communications network 112 can be a local area network (LAN) or a wide area network (WAN). The communications network 112 can include any suitable technology, such as Public Switched Telephone Network (PSTN). Ethernet, 302.11g, SONET, etc. For simplicity, the metadata-enhanced instant-messaging network 100 shows only six client network devices 104, 124 and two server network devices 108, 128 connected to the communications network 122. In practice, there may be a different number of clients and servers. Also, in some instances, a client may perform the functions of a server and a server may perform the functions of a client device. Additionally, the clients 104, 124 can connect to the communications network 122 and exchange data with other devices in their respective networks 112, 118 or other networks (not shown).

### Metadata-Enhanced Instant-Messaging Application Device Architecture

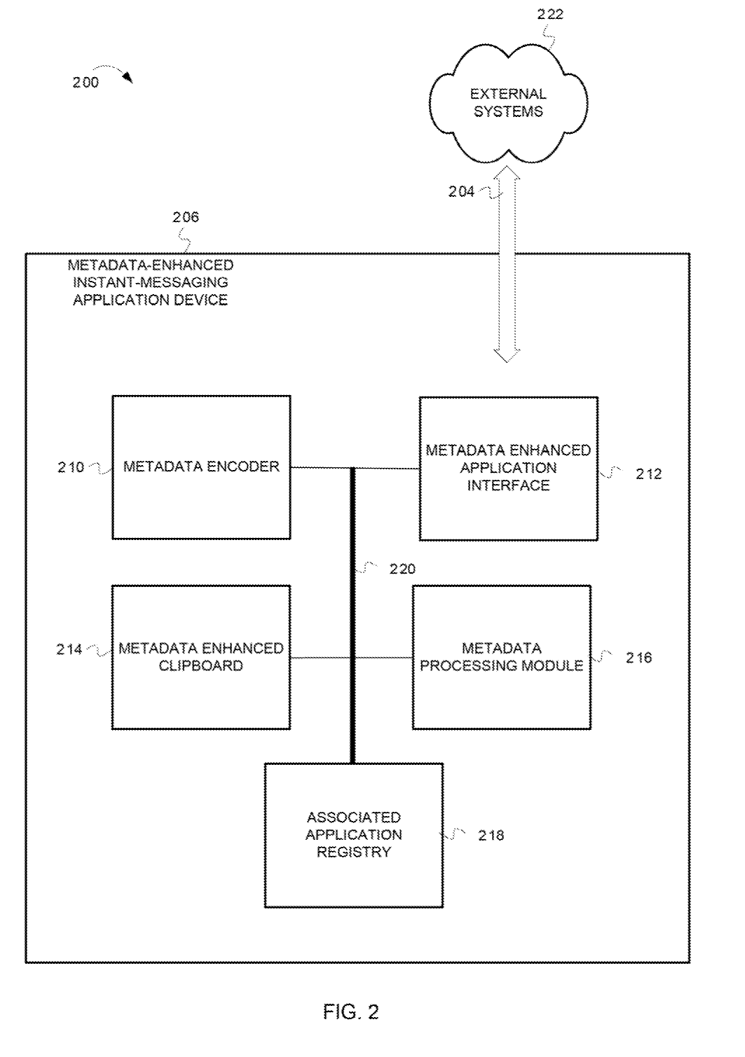

FIG. 2 is an illustration of an architecture 200 of a metadata-enhanced instant-messaging application device 206, according to some embodiments of the invention. In FIG. 2, the instant-messaging device 206 has a metadata encoder 210 to encode metadata by creating metadata and binding it to data, or in other words, creating an association to the data. The metadata encoder 210 can also encode metadata by incorporating it into a markup script or computer language. The metadata encoder 210 can also decode or separate metadata that is bound to data. The instant-messaging device 206 also has a metadata enhanced clipboard 214 that copies data and metadata from an application to a clipboard 214, and from the clipboard 214 to an instant-messaging application. The instant-messaging device 206 also has a metadata processing module 216 to analyze metadata and perform operations within an instant-messaging application that reads metadata, displays data in a screen, associates applications to types associated with data and metadata, etc. The instant-messaging device 206 also has an associated application registry 218 with designations that store the types and information about the software applications that associate with those types. Additional, the instant-messaging device 206 also has a metadata enhanced application interface 212 to communicate data and metadata between the instant-messaging device 206 and other external metadata enhanced software applications. The instant-messaging device 206 can also include a communications interface 220 to facilitate communication within the instant-messaging device 206. The communications interface 220 represents any suitable method of communication (bus, wire, parameter passing, message passing, etc.).

### Computer System

FIG. 3 is a block diagram illustrating a computer system 300, according to some embodiments of the invention. In FIG. 3, a computer system 300 includes a CPU 302 connected to a system bus 304. The system bus 304 is connected to a memory controller 306 (also called a north bridge), which is connected to a main memory unit 308, AGP bus 310 and AGP video card 312. The main memory unit 308 can include any suitable memory random access memory (RAM), such as synchronous dynamic RAM, extended data output RAM, etc. The main memory 308 can also include a metadata-enhanced instant-messaging application 309. An expansion bus 314 connects the memory controller 306 to an input/output (I/O) controller 316 (also called a south bridge). According to embodiments, the expansion bus 314 can be include a peripheral component interconnect (PCI) bus, PCLX bus, PC Card bus, CardBus bus, InfiniBand bus, or an industry standard architecture (ISA) bus, etc.

The I/O controller is connected to a hard disk drive (HDD) 318, digital versatile disk. (DVD) 320, input device ports 324 (e.g., keyboard port, mouse port, and joystick port), parallel port 338, and a universal serial bus (USB) 322. The USB 322 is connected to a USB port 340. The I/O controller 316 is also connected to an XD bus 326 and an ISA bus 328. The ISA bus 328 is connected to an audio device port 336, while the XD bus 326 is connected to BIOS read only memory (ROM) 330.

In some embodiments, the computer system 300 can include additional peripheral devices and/or more than one of each component shown in FIG. 3. For example, in some embodiments, the computer system 300 can include multiple external multiple CPUs 302. In some embodiments, any of the components can be integrated or subdivided.

Any component of the computer system 300 can be implemented as hardware, firmware, and/or machine-readable media including instructions for performing the operations described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

### Example Operations in an Operating Environment

This section describes operations associated with some embodiments of the invention. In the discussion below, the flow diagrams will be described with reference to block diagrams presented herein. In certain embodiments, the operations are performed by executing instructions residing on machine-readable media (e.g. software), while in other embodiments, the operations are performed by hardware and/or other logic (e.g., firmware). In some embodiments, the operations are performed in series, while in other embodiments, one or more of the operations can be performed in parallel. Moreover, some embodiments perform less than all the operations shown in the flow diagrams.

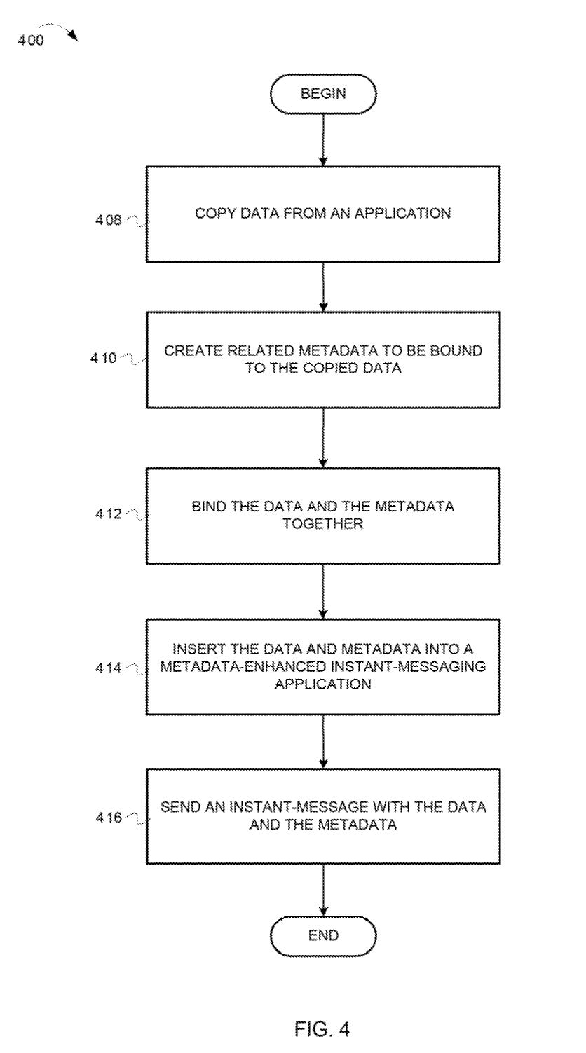

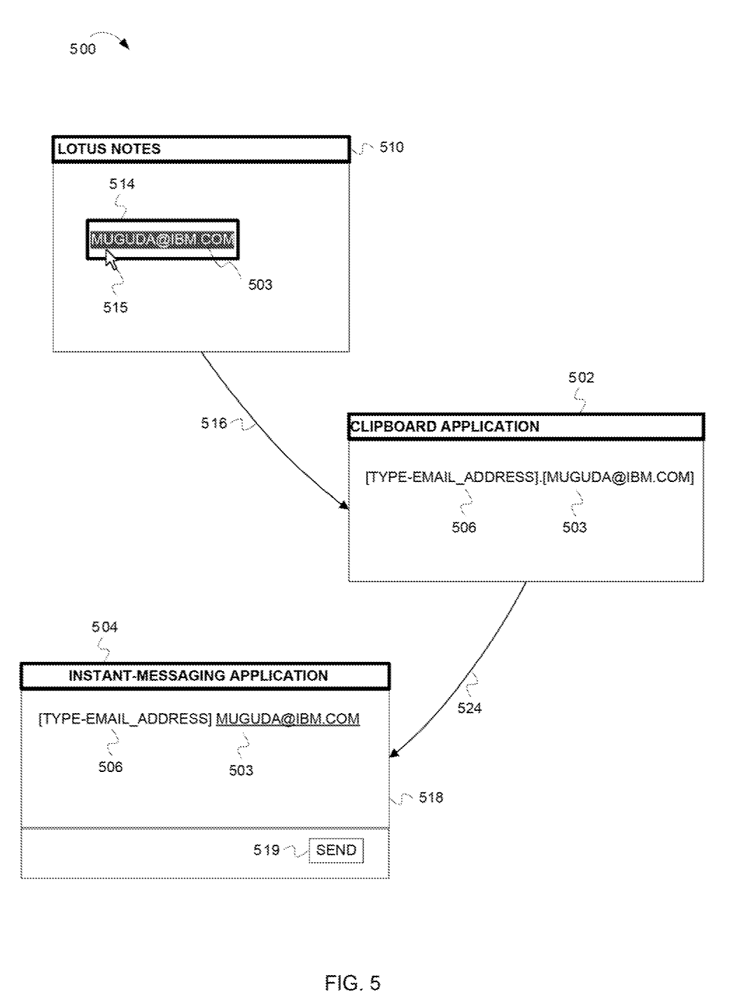

FIG. 4 is a flow diagram of a method 400 according to some embodiments of the invention. FIG. 5 illustrates an embodiment of method 400 in an operating environment and will be described in concert with FIG. 4, according to some embodiments of the invention. In FIG. 4, the method 400 begins at processing block 408. At block 408, an application program selects and copies data. For example, as shown in FIG. 5, an application program 510 enables a user to employ a mouse pointer 515 to select data 503 within the application program 510. In the application program 510, a field 514 or other object can include the data 503. The data 503 could include any type of electronically stored information, such as a text string, a graphic, a document, etc. Additionally, the data 503 can include any electronic information that can be embedded into an instant-message and transmitted electronically. After selecting the data 503, the application program 510 copies the data to a clipboard application 502. The application program 510 can copy data to the clipboard application 502 by performing a copy operation in response to a user pressing Ctrl+C on a keyboard, selecting a copy function from a dropdown menu, clicking a “Copy” button on a toolbar, etc. In FIG. 5, the copy operation is indicated by an arrow 516 between the application program 504 and the clipboard application 502.

In FIG. 4, the method 400 continues at processing block 410 where an application creates related metadata to be appended to the copied data. In FIG. 5, the application 510 creates metadata 506. The application 510 can create metadata that relates to the data 503 or the application 510. For example, if the application 510 is an email and calendaring application, the data 503 could be a name, date, email address, etc. The metadata could be a type that relates to the data (e.g., type-email_address, type-contact_vcard, type-meeting_invitation, etc.) or a type that relates to the application (e.g., type-email, type-calendar, etc.). The application 510 can create other metadata including specific properties and attributes of the data (e.g., font-red, data_type-text, etc.), time/date information (e.g., create_date, create_time, etc.), families of higher types (e.g., classes, methods, objects, etc.), etc. In FIG. 5, the application 510 creates the metadata 506 as a type, such as “type-email_address”.

In FIG. 4, the method 400 continues at block 412 where the application binds the data and metadata together. In FIG. 5, the application 510 binds or attaches the metadata 506 with the data 503, shown by arrow 516, and places the bound data 503 and metadata 506 into clipboard application 502 (“clipboard”). The metadata 506 and data 503 are still distinctly different values, but they are associated with each other so that they can move in tandem throughout subsequent operations.

In FIG. 4, the method 400 continues at block 414 where a clipboard inserts the data and metadata into a metadata-enhanced instant-messaging application. In FIG. 5, the clipboard application 502 inserts the metadata 506 and data 503 directly into the display screen 518 of a sender's metadata-enhanced instant-messaging application (“instant-messaging application”) 504. The clipboard 504 can accomplish this via a “paste” operation, show by arrow 524. The sender's instant-messaging application is configured to receive both metadata 506 and the data 503, and to display both appropriately to the user. For example, the instant-messaging application 504 displays the data 503 to the user in a way that stand's out from normal text, such as by underlining the data 503, bolding the data 503, highlighting the data 503 with color, etc. The instant-messaging application 504 formats the metadata 506 to be hidden from view (shown as bracket's in FIG. 5), but still bound with the data 503. For example, the instant-messaging application 504 can encode the metadata 506 through a class construct, such as HTML or the markup language of the environment.

In FIG. 4, the method 400 continues at block 414 where the instant-messaging application sends a message that contains the data and metadata. In FIG. 5, the instant-messaging application 504 allows a user to send the message, such as by providing a “Send” button 519 for the user to click. The instant-messaging application 504 then sends the message (including the meta data and data) over the network 122. Eventually, a second client 124 receives and presents the message. Each of the various servers 108, 128 can interact with the message, the networks 122, 112, 118, the clients 104, 124 or each other.

This description continues with a discussion about how application programs can receive and process instant-messages that include data and metadata.

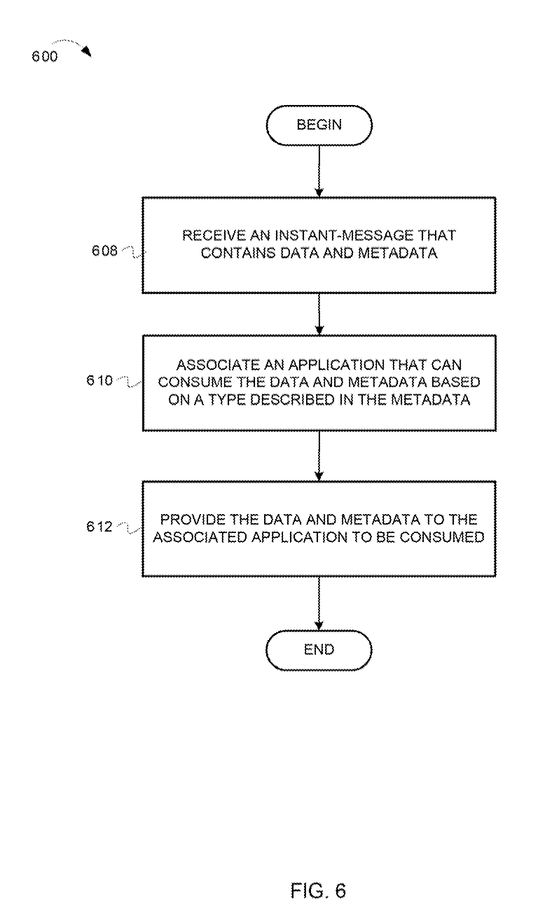

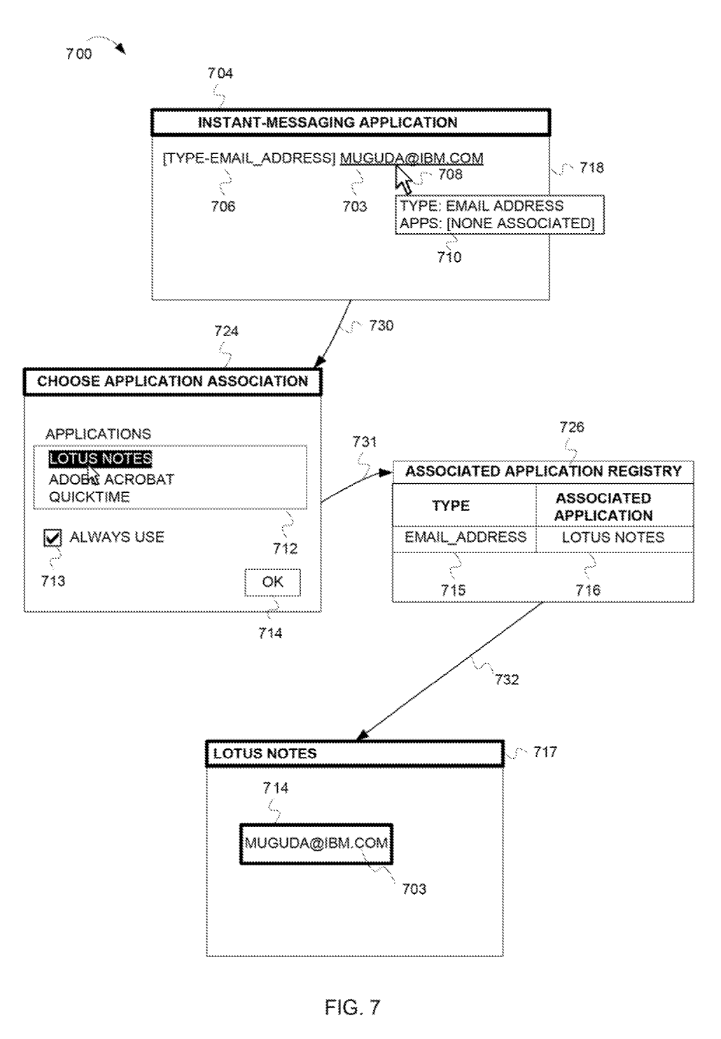

FIG. 6 is a flow diagram of a method 600 according to some embodiments of the invention. FIG. 7 illustrates an embodiment of method 600 in an operating environment and will be described in concert with FIG. 6, according to some embodiments of the invention. This description will present FIG. 6 in concert with FIG. 7. In FIG. 6, the method 600 begins at processing block 608 where a metadata-enhanced instant-messaging application receives an instant-message. In FIG. 7, a receiver's metadata-enhanced instant-messaging application 704 (“instant-messaging application”) receives the message (e.g., the message sent at block 612 of FIG. 6). The receiver's instant-messaging application 704 is configured to receive both metadata 706 and the data 703, and to display both appropriately to the receiver user. For example, the instant-messaging application 704 displays the data 703, but hides the metadata 706, similar to the instant-messaging application 504 described above. Furthermore, instant-messaging application 704 can display to the user some of the information contained in the metadata 706 or prompt the user for action. For example, the application 704 detects a mouse pointer 708 over the displayed data 706, the instant-messaging application 704 can display a pop-up message 710, which can show some of the metadata 706 in a way that is understandable to the user.

In FIG. 6, the method 600 continues at block 610 where the instant-messaging application 704 allows a user to select an application that can consume the data and metadata. In one embodiment, the selected application becomes associated with the data and metadata. As a result, the associated application will consume the data 703 and metadata 706 based on a type described in the metadata 706. In FIG. 7, the instant-messaging application recognizes that the data 703 has a type (e.t., “type-email_address”) described in the metadata 706, but it also knows that the type is not currently associated with any software application that could assimilate the data. Consequently, the instant-messaging application 704 performs an operation, shown by arrow 730. The instant-messaging application 704 allows the user to select an application that relates to the type that characterizes the data. The instant-messaging application 704 can perform the operation automatically once it receives a message that contains an unknown type. On the other hand, the instant-messaging application 704 can wait for the user to initiate the operation, such as by moving the mouse cursor 708 over the displayed data 703, or by clicking on the displayed data 703.

The instant-messaging application 704 then presents a screen 724 to the user. The screen 724 allows a user to select an application entry from a list 712 of accessible software applications. The user can select the application entry with a mouse click on the desired entry and a button 714 click to confirm the selection. The screen 724 includes a checkbox 713, or similar means, for configuring the instant-messaging application 704 to remember the selection. As a result, the instant-messaging application 704 performs another operation, shown by arrow 731. The instant-messaging application 704 writes information about the selected application entry to an associated application registry 726. The instant-messaging application 704 writes the type into a “type” designation 708 and the application name, executable file path, etc., in an “associated application” designation 716 that directly relates to the type. The instant-messaging application 704 can write enough information into the associated application designation 716 to allow the instant-messaging application 704 to launch the actual associated application 717 that will consume the data 703 and metadata 706.

In FIG. 6, the method 600 continues at processing block 612 where the instant-messaging application 704 provides the data 703 and metadata 706 to the associated application 710 so that the associated application 710 can consume the data 703 and metadata 706. In FIG. 7, the instant-messaging application 704 performs an operation, shown by arrow 732. The instant-messaging application can launch the associated application 717 or detect that the application is already running. Then, it can provide the data 703 and metadata 706 to the associated application 717 for consumption. The associated application 717 is enhanced with the necessary configurations so that it can (1) receive the metadata 706 and data 703 from the instant-messaging application 704, (2) analyze the metadata 706 and data 703 to determine what operations to perform within the associated application 717, and (3) perform those operations within the associated application. Some example operations may include opening specific records, writing entries to a record, causing events to occur, running queries, etc. For example, in one embodiment, the associated application 717 knows that the data 703 is of type “email_address” because that type is contained within the metadata 706. Hence, the associated application 717 runs a search to query a database of the records for an email address that includes all or a portion of the data value, in this case “muguda@ibm.com”. When the associated application 717 finds a matching entry in the database, it can open the corresponding record associated with the email address, such as Mr. Muguda's contact record. The associated application 717 can then open the record form within a user interface.

This description continues with a discussion about how instant messaging applications process metadata and interact with applications that consume the metadata.

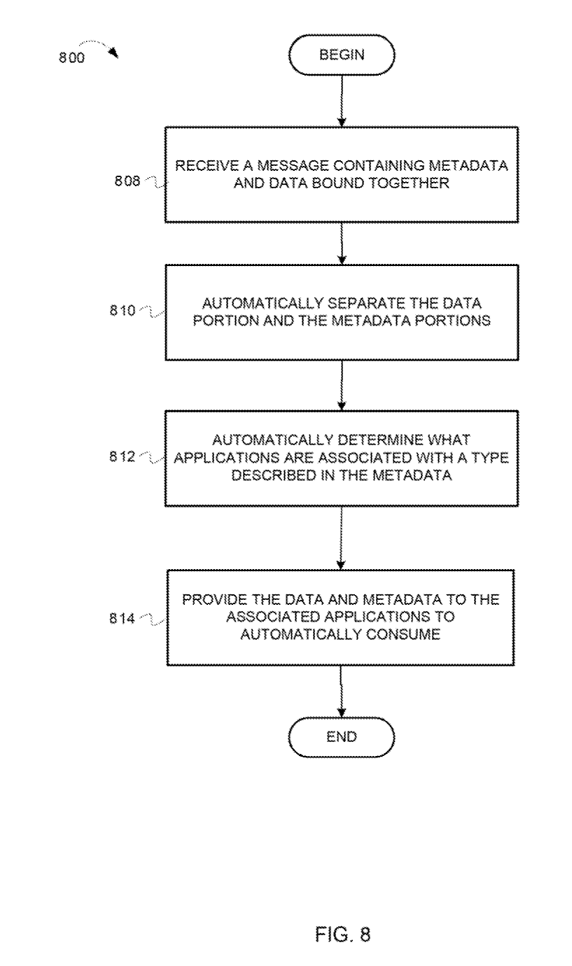

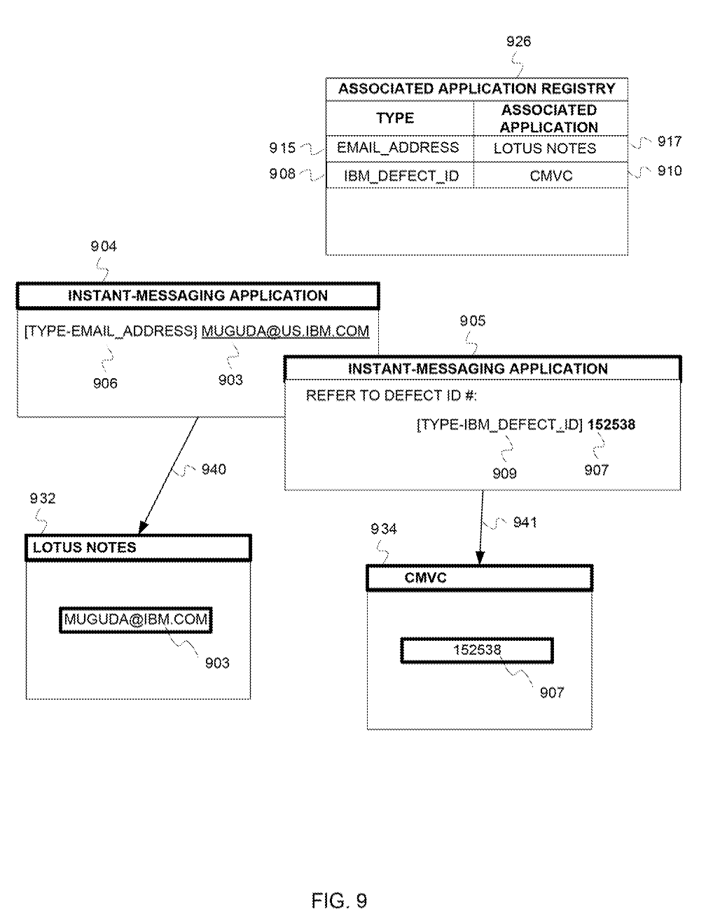

FIG. 8 is a flow diagram of a method 800 according to some embodiments of the invention. FIG. 9 illustrates an embodiment of method 800 in an operating environment and will be described in concert with FIG. 8, according to some embodiments of the invention. This description will present FIG. 8 in concert with FIG. 9. In FIG. 8 the method 800 begins, at processing block 808, with an instant-messaging application receiving a message containing metadata and data bound together. In FIG. 9, a first instant-messaging application 904 receives data 903 and metadata 906. Metadata 906 contains data 903 of a first type (e.g., “email_address”) as described by metadata 906. Furthermore, a second instant-messaging application 905 can also operate on the same client machine. The second instant-messaging application 905 contains data 907 of a second type (e.g., “IBM_defect_ID”) as described by metadata 909.

The instant-messaging applications 904 and 905 both read from a pre-configured associated application registry 926 that includes type designations and associated applications designations. A first type designation 915 relates to the first type (e.g. “email address”) that had been previously set by a user (see discussion above). The first type is contained within metadata 906. A first associated application designation 917 includes an associated application entry corresponding to a local application 932 that consumes data 906 of the first type (e.g., “email_address”). Likewise, a second type designation 915 relates to a second type (e.g. “IBM_defect_ID”). That second type is contained within metadata 906 of instant-messaging application 905. A second associated application designation 910 includes an associated application entry corresponding to a local application 934 that consumes data 907 of the second type (e.g. “IBM_defect_ID”).

In FIG. 8 the method 800 continues, at processing block 810, with the instant-messaging application automatically separating the data portion of an instant-message from the metadata portion of the instant-message. In FIG. 9, the instant-messaging application 904 realizes that bound data 903 and metadata 906 have appeared in an instant-message. The instant-messaging application 904, therefore, automatically separates and distinguishes the data 903 and metadata 906 to utilize the values for subsequent operations. Likewise, instant-messaging application 905 does the same thing for bound data 907 and metadata 909.

In FIG. 8 the method 800 continues, at processing block 812, with the instant-messaging applications analyzing the metadata to determine what applications are associated with the types described in the metadata. In FIG. 9, the instant-messaging application 905 analyzes metadata 906 by reading the type contained within the metadata 906 (e.g., “type-email_address”), then by searching the associated application registry 926 to find a matching designation, such as designation 915, that contains the type described in metadata 906. The instant-messaging application 906 then reads horizontally to the designation 917 that corresponds to the first type designation 915. The application entry listed in designation 917 is the application that has been preconfigured to consume data of the type described in metadata 906 (e.g., type “email address”). Likewise, the second instant-messaging application 905 searches the associated application registry and finds the matching designation 908 that corresponds to type “IBM_defect_ID” contained in metadata 909, and looks to designation 910 for the application entry for the application (e.g., CMVC) that will consume data 907.

FIG. 8 the method 800 continues, at processing block 814, with both instant-messaging applications providing the data and metadata for consumption by their respective associated applications. In FIG. 9, the first instant-messaging application 904 performs an operation, shown by arrow 940. The first instant-messaging application provides data 903 and metadata 906 to a first associated application 932. If the associated application 932 is not already running, then the first instant-messaging application can automatically launch the associated application 932 without user intervention. The associated application 932 then automatically consumes the data 903 and metadata 906. Likewise, in FIG. 9, the second instant-messaging application 905 performs an operation, shown by arrow 941. The second instant-messaging application 905 provides data 907 and metadata 909 to a second associated application 934. If the second associated application 934 is not already running, then the second instant-messaging application can automatically launch the associated application 932 without user intervention. The associated application 932, then automatically consumes the data 903 and metadata 906. This description continues with a discussion about how instant messaging applications process metadata and data types that can apply to more than one consuming application.

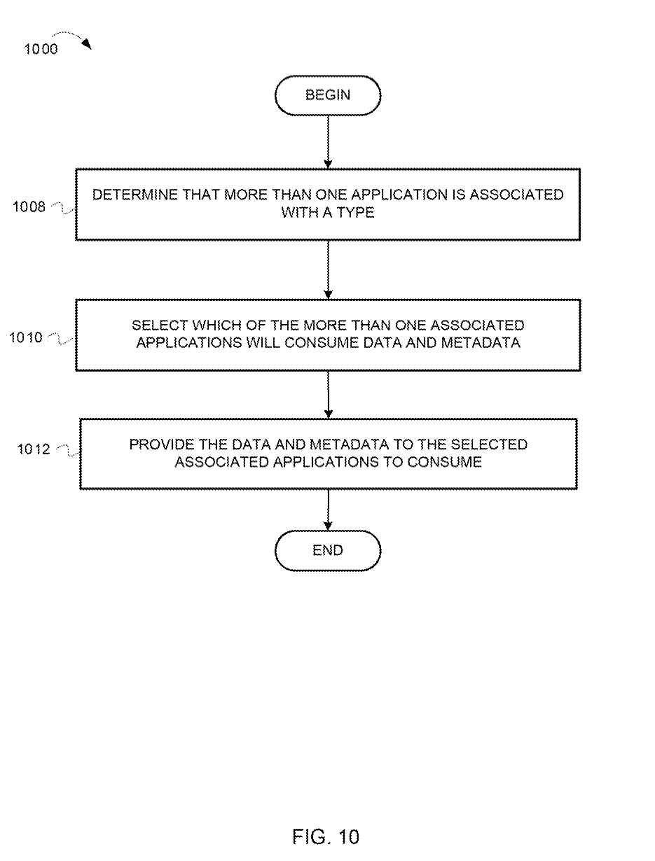

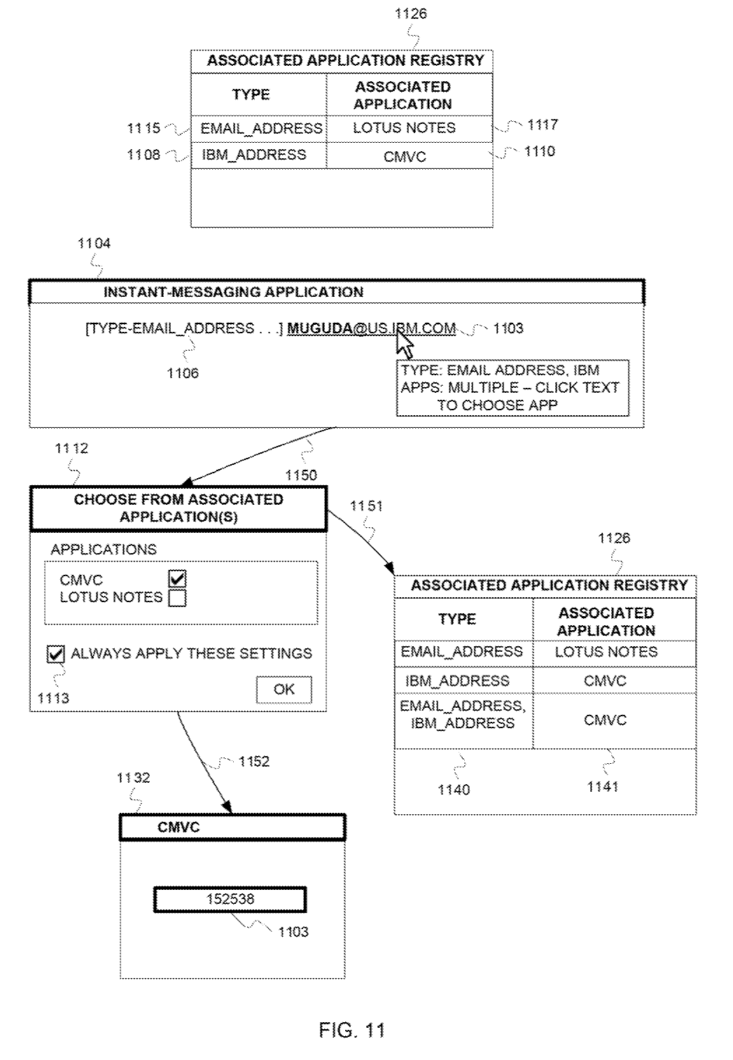

FIG. 10 is a flow diagram of a method 1000 according to some embodiments of the invention. FIG. 11 illustrates an embodiment of method 1100 in an operating environment and will be described in concert with FIG. 10, according to some embodiments of the invention. This description will present FIG. 10 in concert with FIG. 11. In FIG. 10 the method 1000 begins, at processing block 1008, with an instant-messaging application determining if more than one application is associated with a type. Types can be organized into hierarchies, or in other words, more than one application can consume data of a certain type. In FIG. 11, an instant-messaging application 1104 receives a message containing data 1103 such as the email address “muguda@us.ibm.com”. The metadata 1106 includes a first distinguishing type (e.g., “type-email_address”) which describes the data as an “email_address” type. However, the instant-messaging application recognizes, either on its own or with the assistance of metadata 1106, that the email address contained within the data 1103 is also a second type, such as an IBM address. Consequently, the instant-messaging application 1104 looks to its associated application registry 1126 to determine what applications could be associated with first type (e.g., “email_address”) and with the second type (e.g., “IBM_address”). The registry 1126 indicates that the first type, “email_address”, shown in designation 1115, corresponds to a first application, (e.g., “Lotus Notes” email client application), in designation 1117. On the other hand, the registry 1126 indicates that the second type 1104, “IBM_address”, shown in designation 1108, corresponds to a second associated application (e.g., “CMVC” application), in designation 1110. Hence, the instant-messaging application 1104 determines that there are two separate associated applications that can consume the email address data 1103.

In FIG. 10 the method 1000 continues, at processing block 1010, with the instant-messaging application selecting which associated applications will consume the data and metadata. In FIG. 11, the instant-messaging application 1104 presents a selection screen 1112 (shown by arrow 1150), that allows a user to select which of the associated applications will consume the data 1103. The instant-messaging application 1104 allows the user to select one or more of the applications. The instant-messaging application also provides a check-box 1113, or other means, to allow the user to select applications that will consume the data 1102. If the checkbox 1113 is selected, the instant-messaging application 1104 writes the selection to the associated application registry 1126, as shown in designation 1140. The entry in designation 1140 indicates the hierarchical type combination. In designation 1141, the instant-messaging application 1104 writes an entry that indicates the application(s) that the user selected to consume the data 1103.

In FIG. 10 the method 1000 continues, at processing block 1012, with providing the data and metadata to the selected associated application to consume the data. In FIG. 11, the instant-messaging application 1112 provides the data 1103 and metadata 1106, (show by arrow 1152), to the associated application 1132. The associated application 1132, then consumes the data 1103 and the metadata 1106.

### General

This description describes numerous details about embodiments of the invention. However, some embodiments may be practiced without these specific details. In some instances, for sake of clarity, this description omits well-known circuits, structures and techniques. In this description, references to “one embodiment” or “an embodiment” mean that a feature is included in at least one embodiment of the invention. Furthermore, separate references to “one embodiment” do not necessarily refer to the same embodiment. Thus, the present invention can include any combination the embodiments described herein.

1. A method, comprising:
analyzing metadata included in an instant-message, wherein the instant-message also contains data;
associating the data and metadata with a software application that can consume the data and metadata; and
providing the data and metadata to the software application to consume the data and metadata.

2. The method of claim 1, wherein the data comprises electronic information embedded in the instant-message.

3. The method of claim 1, wherein the metadata is of a type that characterizes the data.

4. The method of claim 1, wherein the metadata contains information selected from the group consisting of a type that characterizes the data, an attribute of the data, time and date, and higher types.

5. The method of claim 1, further comprising:
inserting an entry into an application registry where the entry indicates the type and the software application.

6. The method of claim 1, further comprising:
allowing a user to select from a list of available software applications to associate the data and metadata with the software application.

7. The method of claim 1, wherein the metadata is not displayed in the instant-messaging application.

8. The method of claim 1, wherein the instant-messaging application is configured to recognize the type and provide the data and metadata to the software application.

9. A computer program product comprising:
a computer usable medium having computer usable program code for associating data and metadata with a software application that can consume the data and metadata, said computer program product comprising,
computer usable program code for analyzing metadata included in an instant-message, wherein the instant-message also contains data;
computer usable program code for associating the data and metadata with a software application that can consume the data and metadata; and
computer usable program code for providing the data and metadata to the software application to consume the data and metadata.

10. The computer program product of claim 9, wherein the metadata is of a type that characterizes the data.

11. The computer program product of claim 9, wherein the instant-messaging application is configured to recognize the type and provide the data and metadata to the software application.

12. A method comprising:
copying data from a software application;
creating metadata based on the data;
creating an association between the data and metadata;
inserting the data and metadata into an instant-messaging application; and
displaying the data within the instant-messaging application to indicate that metadata is associated with the data.

13. The method of claim 12, wherein the metadata is not displayed in the instant-messaging application.

14. The method of claim 12, wherein the metadata contains information selected from the group consisting of a type that characterizes the data, an attribute of the data, time and date, and higher types.

15. The method of claim 12, wherein the metadata is of a type that characterizes the data.

16. An apparatus, comprising:
an encoder to associate data and metadata in an instant-message;
a processing module to associate the metadata to a software application; and
an application interface to provide the metadata and data to the software application.

17. The apparatus of claim 16, wherein the metadata is of a type that characterizes the data.

18. The apparatus of claim 17, further comprising:
an application registry to store the type and information about the software application.

19. The apparatus of claim 16, further comprising:
a clipboard to copy the data and metadata from a software application and to paste the data and metadata into the instant-message.

20. The apparatus of claim 16, further comprising:
an interface to display the data to indicate that metadata is associated with the data.
